(19) United States
(12) Patent Application Publication
(10) Pub. No.: US 2005/0149711 A1
(43) Pub. Date: Jul. 7, 2005

(54) Method and system for firmware-based run time exception filtering

(76) Inventors: Vincent J. Zimmer, Federal Way, WA (US); Michael A. Rothman, Gig Harbor, WA (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/749,079

(22) Filed: Dec. 30, 2003

(51) Int. Cl. G06F 9/00

(52) U.S. Cl. 712/244

(57) ABSTRACT

A method and system for filtering and/or handling operating system (OS) runtime exceptions using firmware-based components. OS-based exception handling components and corresponding pointers, as applicable, are set up in a conventional manner during the OS load. The OS-based components are then physically or logically relocated (moved from a physical to virtual address in one embodiment, re-referencing a base address for the OS-based components in another embodiment) and physically or logically replaced with corresponding firmware-based exception filters/handler components. In response to a runtime exception, the execution stream (i.e., instruction pointer) is vectored to a firmware-based exception filter/handler that performs exception filtering and/or handling for the exception. Upon completion, the execution stream may be re-vectored to a corresponding OS-based exception handler. A firmware-based exception filter/handler may be used to augment an OS-based exception handler, or replace it.

### FIELD OF THE INVENTION

The field of invention relates generally to computer system and, more specifically but not exclusively relates to technique for filtering and/or handling operating system runtime exceptions with firmware-based exception handlers.

### BACKGROUND INFORMATION

Exceptions in computer systems relate to events that are extraordinary or unpredictable, i.e., exceptional. An exception is said to be asynchronous if it is not coordinated with instruction execution; otherwise, the exception is deemed synchronous. An interrupt is an example of an asynchronous exception, whereas a trap is a synchronous exception. For instance, timer and I/O (Input/Output) device request exceptions are interrupts, since neither is directly coordinated with instruction execution. In contrast, a divide by zero error condition produces a synchronous exception, since it results directly from an executed instruction.

Under conventional practices, a currently-executing process is paused in response to an exception, and an exception handler process of the operating system is initiated. This allows the operating system to determine the cause of the exception, and handle it accordingly, taking appropriate steps to service the exception. After the operating system has completed its tasks, the paused process is resumed. The actions taken in response to an exception is referred to as servicing or handling the exception. Although it is common to refer to interrupt handlers and exception handlers as different types of services, they are usually handled internally by the processor in a similar manner. As such, the terms “interrupt” or “interruption” and “exception” are sometimes interchanged.

Generally, exceptions occur when hardware (i.e., a processor) determines that an event has occurred that it cannot handle and must transfer execution control to the operating system. Continuing the above example, the solution to an integer divide-by-zero exception is not obvious. One common solution is to simply terminate the program that caused the exception. Another solution is to ignore the exception (e.g., it could be a floating-point process that caused the exception). Under conventional computer system design practices, neither of the foregoing solutions is implemented in hardware, but rather left to the operating system.

Although operating system exception handling is useful to resolve many exception occurrences, it is limited. In general, an operating system is somewhat abstracted from the underlying platform hardware, enabling a single operating system to run on various different platform configurations. This leads to a situation where an operating system is not designed to handle plafform-specific exceptions. Furthermore, it often would be advantageous to have additional information related to exception handling than is available using the conventional operating system exception handling approach.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic flow diagram illustrating a firmware-based exception filtering/handling process, according to one embodiment of the invention;.

FIG. 1a is a schematic flow diagram illustrating an embodiment of the exception filtering/handling process of FIG. 1 implemented with an Intel® IA-32 architecture processor, according to one embodiment of the invention;

FIG. 1b is a schematic flow diagram illustrating an embodiment of the exception filtering/handling process of FIG. 1 implemented with an Intel® IA-32 architecture processor, according to another embodiment of the invention;

FIG. 2 is a schematic diagram illustrating details of an interrupt descriptor table register and interrupt descriptor table used by an Intel® IA-32 architecture processor;

FIG. 3 is a schematic diagram illustrating details of a task gate, interrupt gate, and trap gate for an Intel® IA-32 architecture processor;

FIG. 4 is a schematic diagram illustrating details of how an interrupt procedure address is located using an Intel® IA-32 architecture processor interrupt descriptor table;

FIG. 5 is a schematic flow diagram illustrating a firmware-based exception filtering/handling process, according to one embodiment of the invention;

FIG. 5a is a schematic flow diagram illustrating an embodiment of the exception filtering/handling process of FIG. 5 implemented with an Intel® IA-64 architecture processor, according to one embodiment of the invention;

FIG. 5b is a schematic flow diagram illustrating an embodiment of the exception filtering/handling process of FIG. 5 implemented with an Intel® IA-64 architecture processor, according to another embodiment of the invention;

FIG. 6a is a flowchart illustrating operations performed to set up the embodiments of FIGS. 1a and 5a, according to one embodiment of the invention;

FIG. 6b is a flowchart illustrating operations performed to set up the embodiments of FIGS. 1b and 5b, according to one embodiment of the invention; and

FIG. 7 is a schematic diagram illustrating an exemplary computer system on which aspects of the embodiments described herein may be practiced.

### DETAILED DESCRIPTION OF PREFERRED EMBODIMENTS

Embodiments of methods and systems for performing firmware-based runtime exception filtering and handling are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to, the same embodiment. Furthermore, the particular features, structures, or characteristics may be combined in any suitable manner in one or more embodiments.

The interrupt and exception-handling mechanism of modern processor architectures allows interrupts and exceptions to be handled transparently to application programs and the like. This capacity is facilitated by special hardware functionality that detects exception events, and responds to such events by suspending the current execution thread, saving its context, and “vectoring” execution to an appropriate exception handler. As discussed above, the conventional approach is to use operating system exception handlers to handle or service the exceptions.

According to one embodiment of the invention, the execution process is first vectored to a firmware-based “filter” prior to being vectored to an operating system exception handler. In some embodiments, the firmware filter performs operations that are independent of the OS exception handler. In other embodiments, the firmware filter performs operations that augment operations performed by the OS exception handler. In yet other embodiments, firmware filters provide exception-handling services, removing the need for such services to be performed by an OS exception handler.

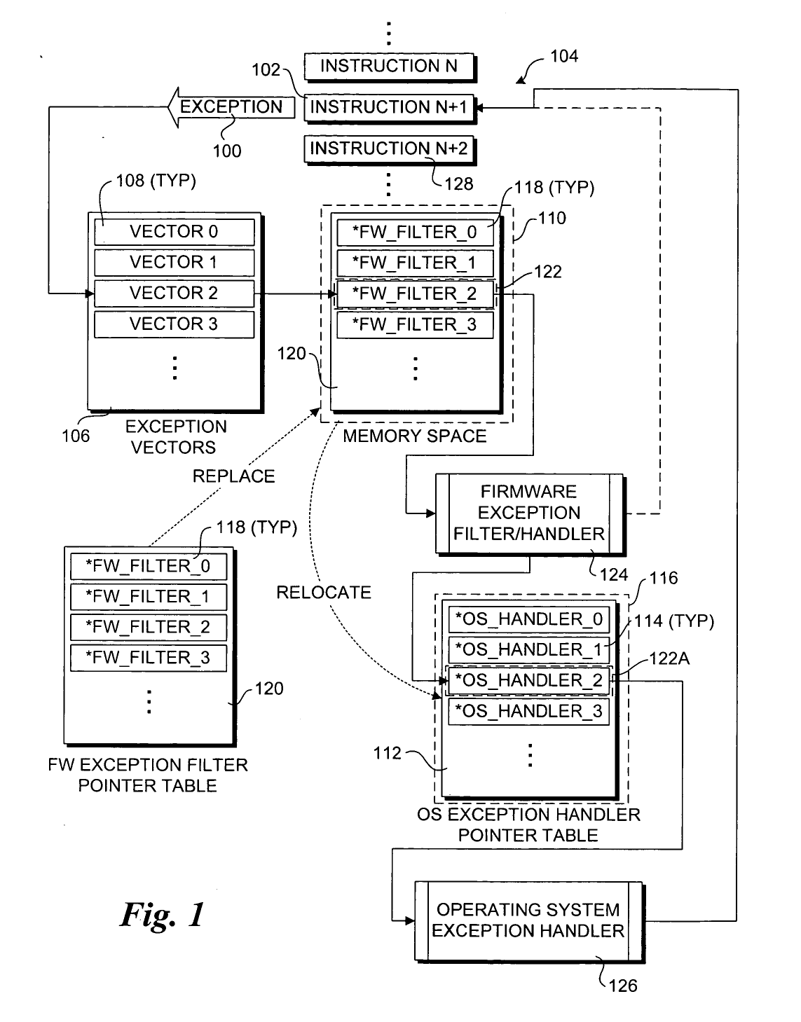

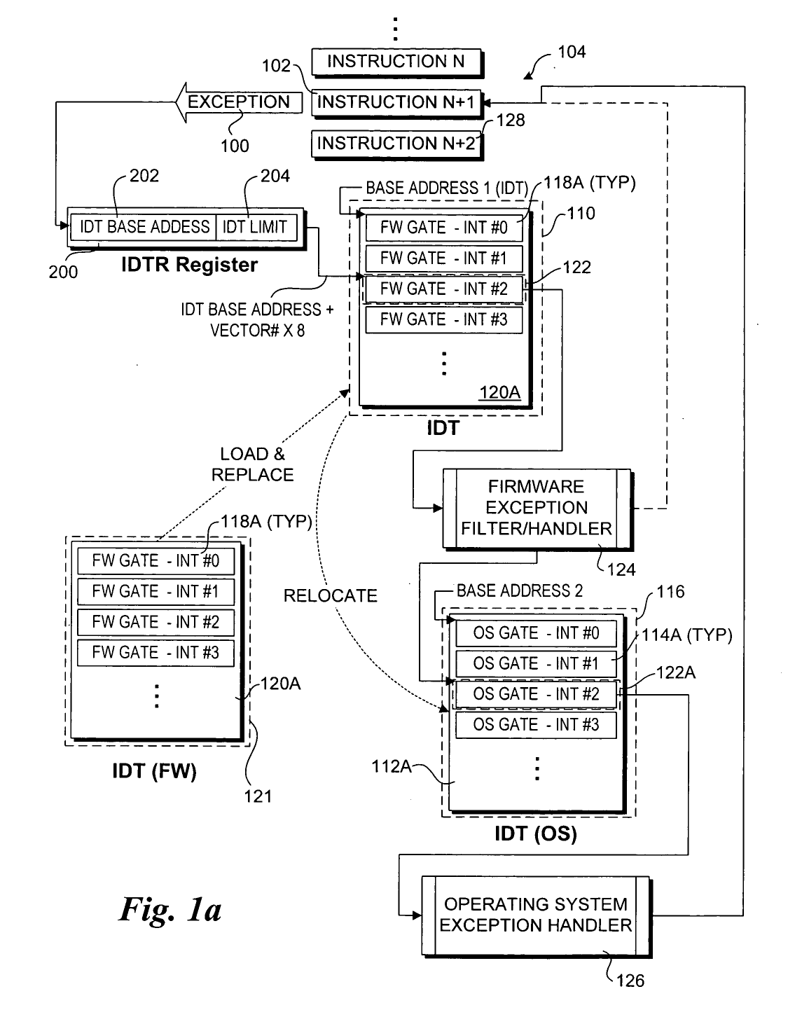

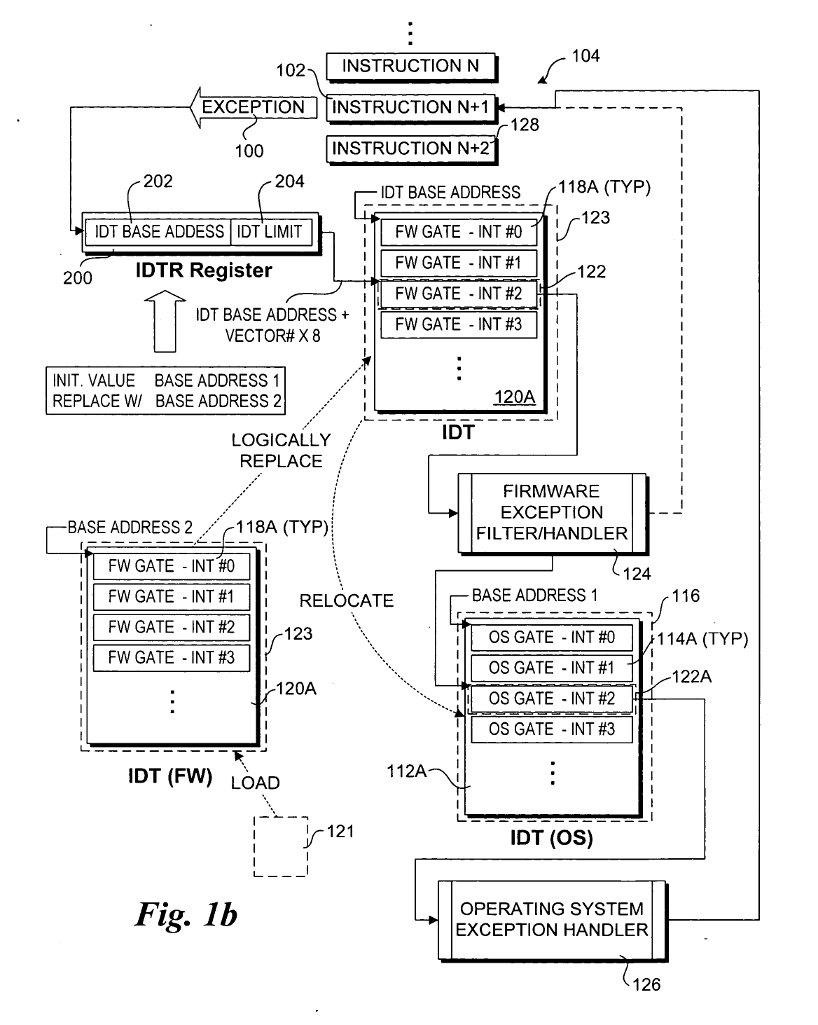

An exception handling process in accordance with one embodiment is shown in FIG. 1. The process begins with the detection of an exception 100 in response to execution of an instruction 102 contained in an instruction stream 104. The exception is internally handled by the processor, including saving the context of the currently-executing process corresponding to instruction stream 104. In general, a respective vector is assigned to each interrupt or exception programmed into the processor. For simplicity, only a set 106 up exception vectors 108 are shown in FIG. 1.

Interrupt and exception vectors are used to “vector” the processor execution path (i.e., instruction pointer) to respective pre-assigned offset addresses in a memory address space 110. In turn, code at each of the pre-assigned addresses is used to launch an appropriate exception handler. Under conventional practices, the operating system provides exception handlers for applicable exceptions. These OS exception handlers are loaded into system memory during the OS load. In conjunction with this, pointers to each of the OS exception handlers are loaded into memory address space 110, which occupies a known portion of the system memory. The pointers are used to re-vector the execution path to the start of a respective OS exception handler. This process is described in further detail below.

In accordance with an aspect of some embodiments, an OS exception handler pointer table 112 including respective OS exception handler pointers 114 is initially loaded at the memory address space 110 by the operating system in the conventional manner. However, the content of pointer table 110 (i.e., OS exception handler pointer table 112) is relocated (either physically or logically) to a new memory address space 116 and replaced with a set of firmware (FW) exception filter pointers 118 contained in a firmware exception filter pointer table 120. In general, physically relocating the, OS exception handler pointers comprises copying the contents to the new memory address space 116, thus relocating the OS exception handler pointers from a physical address to a virtual address. Replacing the content comprises overwriting the previous values in memory address space 110 with the firmware exception filter pointers 118 that are loaded from firmware storage 121. In one embodiment, the firmware storage comprises a local firmware storage device (e.g., a flash memory device or local disk drive). In another embodiment, the firmware exception filter pointers are loaded from a network firmware store.

At this point, an exception 100 is handled in the following manner. For illustrative purposes, it is assumed that exception 100 invokes an exception vector 106 labeled “VECTOR 2” via internal processor operations. The VECTOR 2 exception vector points to the starting address of a memory segment 122 at a known location. During the initial OS load, an OS handler pointer 114 labeled “*OS_HANDLER_{—}2” occupied memory segment 122. However, *OS_HANDLER_2 was relocated and replaced with a firmware filter pointer 118 labeled “*FW_FILTER 2.”

Upon being vectored to the starting address of address segment 122, the instruction stream encounters an instruction contained in firmware filter pointer *FW_FILTER_2 that re-vectors the instruction pointer to the starting address of a firmware exception filter/handler 124. This firmware component contains instructions to perform exception filtering and/or handling operations, as described below in further detail.

In general, when the firmware exception filter/handler 124 is used to only perform filtering operations, exception handling is to be performed by the original operating system exception handler. Accordingly, at the completion of the operations performed by firmware exception filter/handler 124, the instruction pointer is re-vectored to the starting address of a memory segment 122A. This memory segment holds OS exception handler pointer *OS_HANDLER_2. This pointer, in turn, jumps the instruction pointer to the start of an operating system exception handler 126. This OS exception handler services the exception in the conventional manner. That is, the OS exception handler is unaware that firmware-based exception filtering has been previously performed. In the illustrated embodiment of FIG. 1, the instruction pointer is returned to the instruction 102 of instruction stream 104 that caused the exception at the completion of the exception handler operations; however, this is merely illustrative of one common scenario, as the OS exception handling of various types of exceptions may lead to a return to a next instruction 128, other instruction steams, or even a system shut down.

In general, the exception filtering and handling operations may be used to augment related operations performed by an operating system exception handler. For example, exception-filtering operations may include but are not limited to memory dumps, register dumps, stack dumps, data replacements, and working with chipset components to correct errors. A dump typically comprises copying data into some type of store. A store may include another region of memory, a write to a local mass storage device (e.g., disk drive), or a write to a network storage device.

In some instances, the exception handling operations may be entirely performed by the firmware exception handler/filter 124. In this case, the OS exception handler pointer and OS operating system handlers for the exception are bypassed, and the instruction flow returns to instruction set 104. In some cases, the firmware-based exception handling may lead to other flows, such as system shut down.

Under some embodiments, firmware exception handler/filter 124 may be used to perform operations that are not available under the conventional OS exception handler approach. For example, special exception filtering and/or handling may be performed by undefined opcode exceptions. In one embodiment, the operations of the exception filter/handler emulate the opcode behavior and/or communicate with private hardware. For instance, the emulation could image an instruction to do an MPEG4 frame compression. Since firmware-based exception handling operates in a different execution regime than that of the operating system, there are operations and facilities available to the firmware that are not available to the OS. This results in enhanced flexibility in handling exceptions. Furthermore, firmware can be far less abstracted than an operating system, enabling platform-specific exception handling.

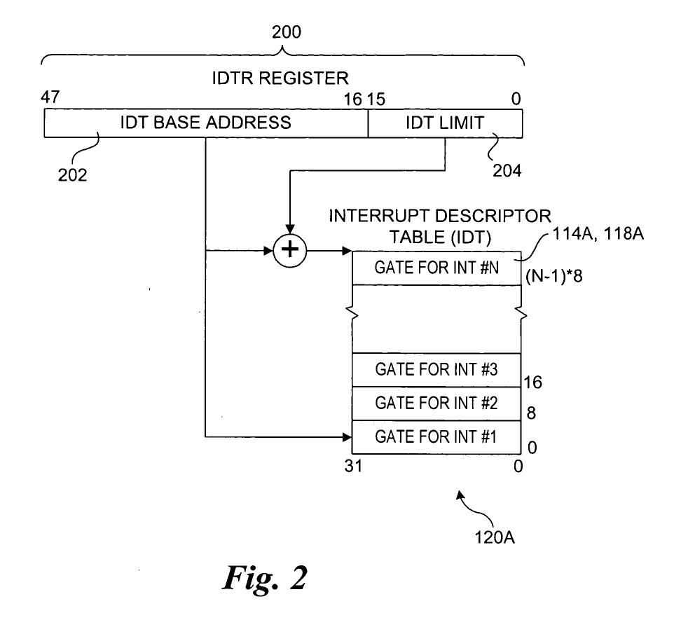

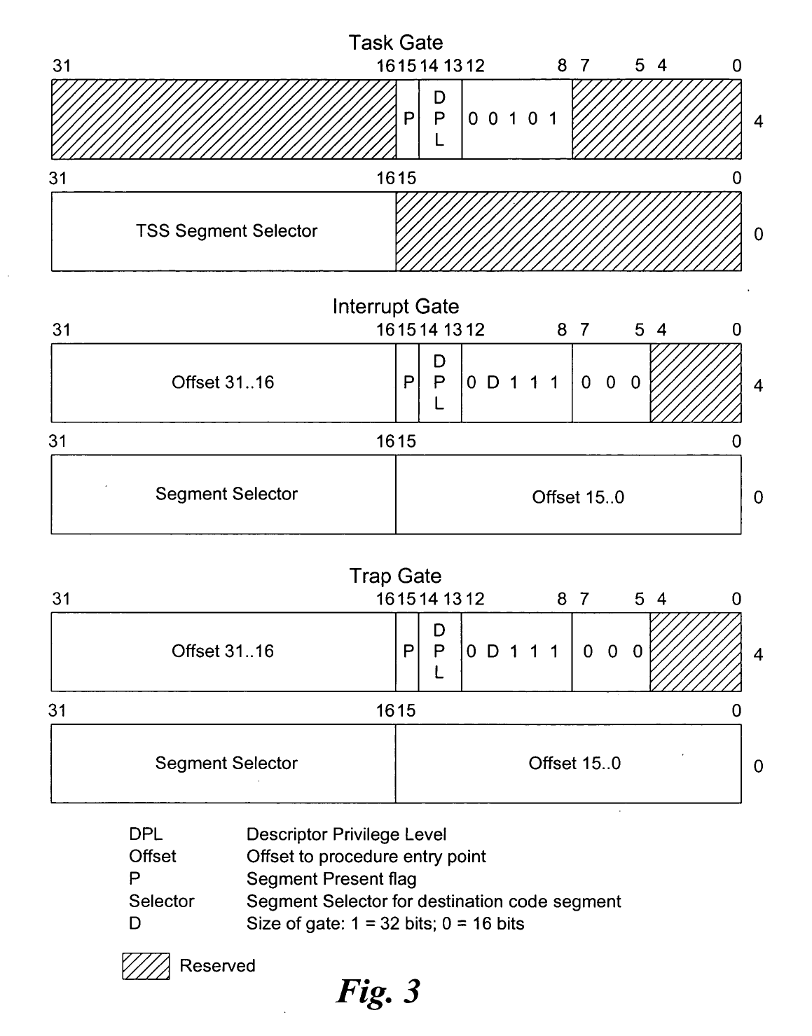

FIG. 1a shows an embodiment that performs exception handling in accordance with the technique of FIG. 1, wherein a 32-bit Intel Architecture (IA-32) processor is used. Under the IA-32 interrupt and exception-handling scheme, the exception vectors 108 are stored in an interrupt description table register (IDTR) 200. As described below with reference to FIG. 2, IDTR register 200 contains a base address from which the instruction pointer is vectored to a corresponding gate descriptor (i.e., entry) in an interrupt descriptor table (IDT) 120A based on an offset defined for that gate descriptor. As described below with reference to FIG. 3, each gate descriptor provides a pointer to the starting point of a corresponding interrupt/exception handling service. The illustrated gate descriptors shown in FIG. 1 a include firmware gate descriptors 118A (which point to respective firmware exception filter/handlers 124), and operating system gate descriptors 114A (which point to respective operating system exception handlers 126).

Under conventional practices, an operating system loads an IDT 112A including appropriate OS gate descriptors 114A into memory during the OS load phase of a computer system. During this same phase, the IDTR register 200 is updated to specify the base address of the memory address space 110 at which the OS gate descriptors 114A are loaded. This base address is defined as base address 1 in the illustrated embodiment of FIG. 1.

An IDT associates each exception or interrupt vector with a gate descriptor for the procedure or task used to service the associated exception or interrupt. Like the GDT (global descriptor table) and LDTs (local descriptor tables), the IDT is an array of 8-byte descriptors (in protected mode). Unlike the GDT, the first entry of the IDT may contain a descriptor. To form an index into the IDT, the processor scales the exception or interrupt vector by eight (the number of bytes in a gate descriptor). The IDT may contain 256 or fewer descriptors; descriptors are required only for the interrupt and exception vectors that may occur.

The base addresses of an IDT should be aligned on an 8-byte boundary to maximize performance of cache line fills. An IDT limit value is expressed in bytes and is added to the base address to get the address of the last valid byte. A limit value of 0 results in exactly 1 valid byte. Because IDT entries are eight bytes long, the limit should always be one less than an integral multiple of eight (that is, 8N−1).

Memory address space 110 may reside anywhere in the linear address space of the system memory. As shown in FIG. 2, the processor locates the IDT using the IDTR register information. The IDTR register 200 holds both a 32-bit IDT base address 202 and 16-bit IDT limit 204. The LIDT (load IDT register) and SIDT (store IDT register) instructions load and store the contents of the IDTR register, respectively. The LIDT instruction loads the IDTR register with the base address and limit held in a memory operand. It normally is used by the initialization code of an operating system when creating an IDT. An operating system (or other entity, such as firmware) also may use it to change from one IDT to another. The SIDT instruction copies the base and limit value stored in IDTR to memory.

Exceptions are classified as faults, traps, or aborts, depending on the way they are reported and whether the instruction that caused the exception can be restarted with no loss of program or task continuity. A fault is an exception that can generally be corrected and that, once corrected, allows the program to be restarted with no loss of continuity. When a fault is reported, the processor restores the machine state to the state prior to the beginning of execution of the faulting instruction. The return address (saved contents of the CS and EIP registers) for the fault handler points to the faulting instruction, rather than the instruction following the faulting instruction.

A trap is an exception that is reported immediately following the execution of the trapping instruction. Traps allow execution of a program or task to be continued without loss of program continuity. The return address for the trap handler points to the instruction to be executed after the trapping instruction (e.g., instruction 128 shown in FIGS. 1, 1a and 1b).

An abort is an exception that does not always report the precise location of the instruction causing the exception and does not allow restart of the program or task that caused the exception. Aborts are used to report severe errors, such as hardware errors and inconsistent or illegal values in system tables.

For fault-class exceptions, the return instruction pointer that the processor saves when it generates the exception points to the faulting instruction. Accordingly, when a program or task is restarted following the handling of a fault, the faulting instruction is restarted (re-executed). Restarting the faulting instruction is commonly used to handle exceptions that are generated when access to an operand is blocked. The most common example of a fault is a page-fault exception (#PF) that occurs when a program or task references an operand in a page that is not in memory. When a page-fault exception occurs, the exception handler can load the page into memory and resume execution of the program or task by restarting the faulting instruction. To insure that this instruction restart is handled transparently to the currently executing program or task, the processor saves the necessary registers and stack pointers to allow it to restore itself to its state prior to the execution of the faulting instruction.

For trap-class exceptions, the return instruction pointer points to the instruction following the trapping instruction. If a trap is detected during an instruction that transfers execution, the return instruction pointer reflects the transfer. For example, if a trap is detected while executing a JMP instruction, the return instruction pointer points to the destination of the JMP instruction, not to the next address past the JMP instruction. All trap exceptions allow program or task restart with no loss of continuity. For example, the overflow exception is a trapping exception. Here, the return instruction pointer points to the instruction following the INTO instruction that tested the OF (overflow) flag in the EFLAGS register. The trap handler for this exception resolves the overflow condition. Upon return from the trap handler, program or task execution continues at the next instruction following the INTO instruction.

The abort-class exceptions do not support reliable restarting of the program or task. Abort handlers generally are designed to collect diagnostic information about the state of the processor when the abort exception occurred and then shut down the application and system as gracefully as possible. One advantage offered by embodiments of the invention is that a firmware-based abort exception handler may store information that is not available to the operating system, as operating systems are generally not allowed to control or have access to all system memory, chipset, and processor registers.

FIG. 3 shows the formats for the task-gate, interrupt-gate, and trap-gate descriptors for IA-32. The format of a task gate used in an IDT is the same as that of a task gate used in the GDT or an LDT. The task gate contains the segment selector of a TSS for an exception and/or interrupt handler task. Interrupt and trap gates are very similar to call gates. They contain a far pointer (segment selector and offset) that the processor uses to transfer program execution to a handler procedure in an exception- or interrupt-handler code segment.

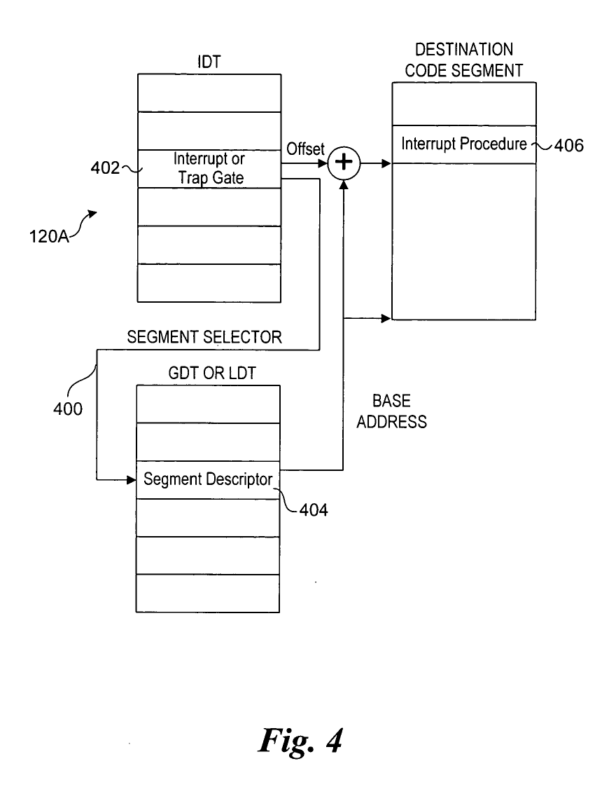

An interrupt gate or trap gate references an exception- or interrupt-handler procedure that runs in the context of the currently executing task, as shown in FIG. 4. A segment selector 400 for a gate 402 points to a segment descriptor 404 for an executable code segment in either the GDT or the current LDT. The offset field of the gate descriptor points to the beginning of the exception- or interrupt-handling procedure 406. In the context of the embodiment shown in FIG. 1a, the firmware exception filter/handler 124 corresponds to the exception- or interrupt-handling procedure 406 for the firmware-based phase of the exception handing process, while the operating system exception handler 126 corresponds to the exception- or interrupt-handling procedure 406 for the OS phase of the exception handling process.

Continuing with the embodiment of FIG. 1a, at some point in conjunction with the operating system load phase, the operating system IDT 112A is relocated from memory address space 110 (having a base address 1) to memory address space 116 having a base address 2. Thus, at the conclusion of execution of firmware exception filter/handler 124, the instruction pointer is re-vectored to the start of an appropriate OS exception handler pointer based on the base address of the OS IDT (base address 2 in the illustrated embodiment) plus an offset that is equal to the original vector number for the exception multiplied by 8 bytes. The OS exception handler pointer (OS GATE—INT #2 in FIG. 1a) then jumps the instruction pointer to the start of its corresponding operating system exception handler.

In general, the location of each operating system exception handler is determined by the operating system. Typically, the operating system will provide a mechanism to support a jump to a known location for each exception handler, with the jump coded into the corresponding OS exception handler pointer 114A. For example, the operating system may always locate its OS exception handlers at predetermined physical addresses within system memory, while respective OS exception handler pointers 114A are hard-coded to those addresses. Alternatively, the OS exception handlers may be located at predetermined virtual addresses, with the operating system providing some mechanism to jump execution to those addresses via corresponding OS exception handler pointers 114A.

A variant of the embodiment of FIG. 1a is shown in FIG. 1b. The operations performed under this embodiment are similar to those performed by the embodiment of FIG. 1a, except for the following differences. Rather than copy the contents of the OS IDT to a new memory address space, the IDT base address 202 in IDT register 200 is changed from an initial value specified by the operating system that references base address 1 (i.e., the base address of memory address space 110 at which the OS IDT 112A is located) to a replacement value specifying a base address 2 of a memory address space 123 at which the firmware IDT 120A is loaded into memory. This results in a logical replacement of the contents of the OS IDT 112A with the firmware IDT 120A.

The process flow shown in FIG. 1b proceeds in a manner substantially analogous to that described above for the embodiment of FIG. 1a. However, at the conclusion of the execution of firmware exception filter/handler 124, the instruction pointer is re-vectored to base address 1 plus the vector offset rather than base address 2 plus the vector offset. This embodiment has an advantage over the embodiment of FIG. 1a in the respect that none of the OS exception handler code needs to be moved once it is loaded.

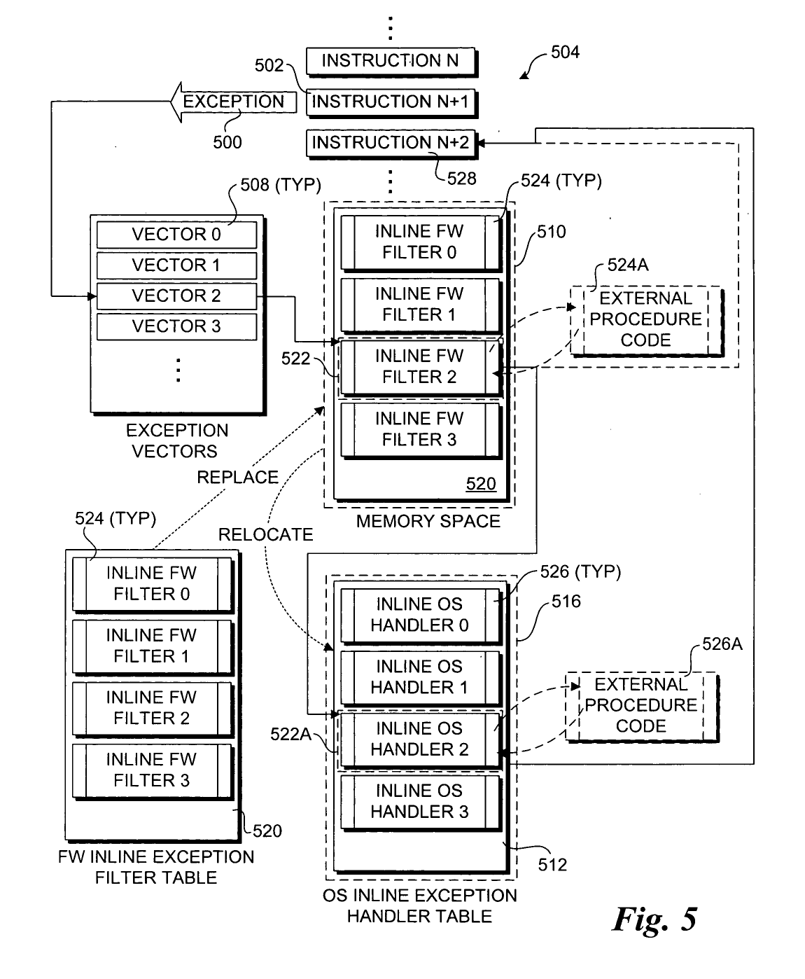

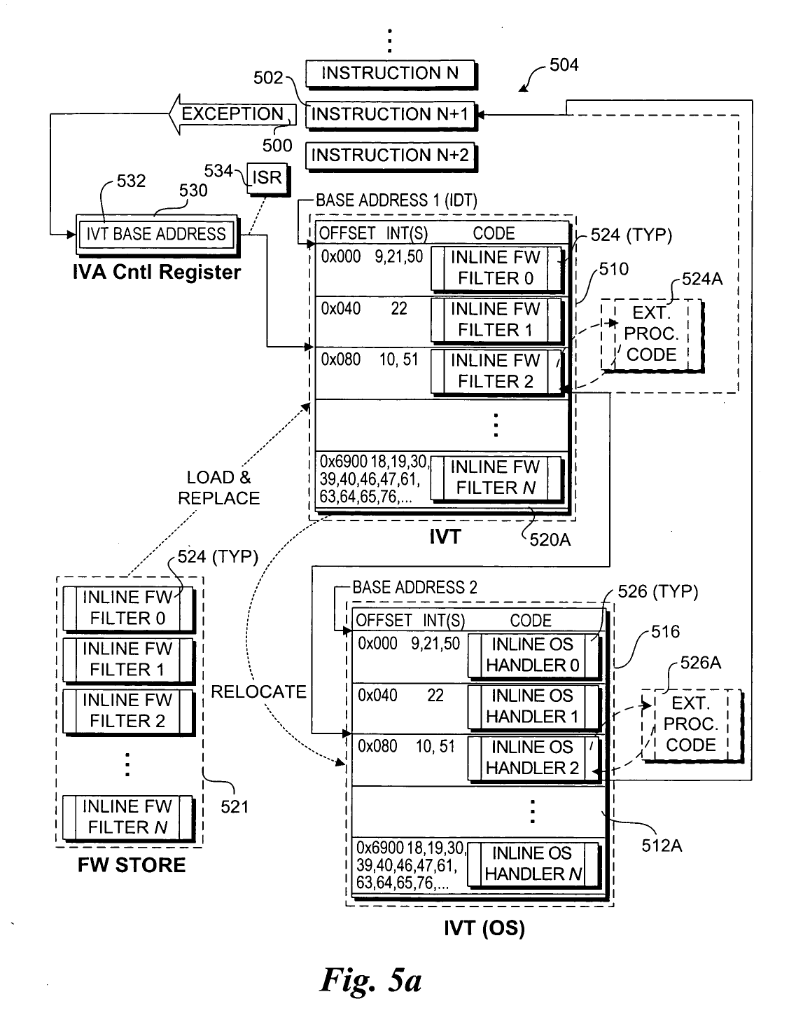

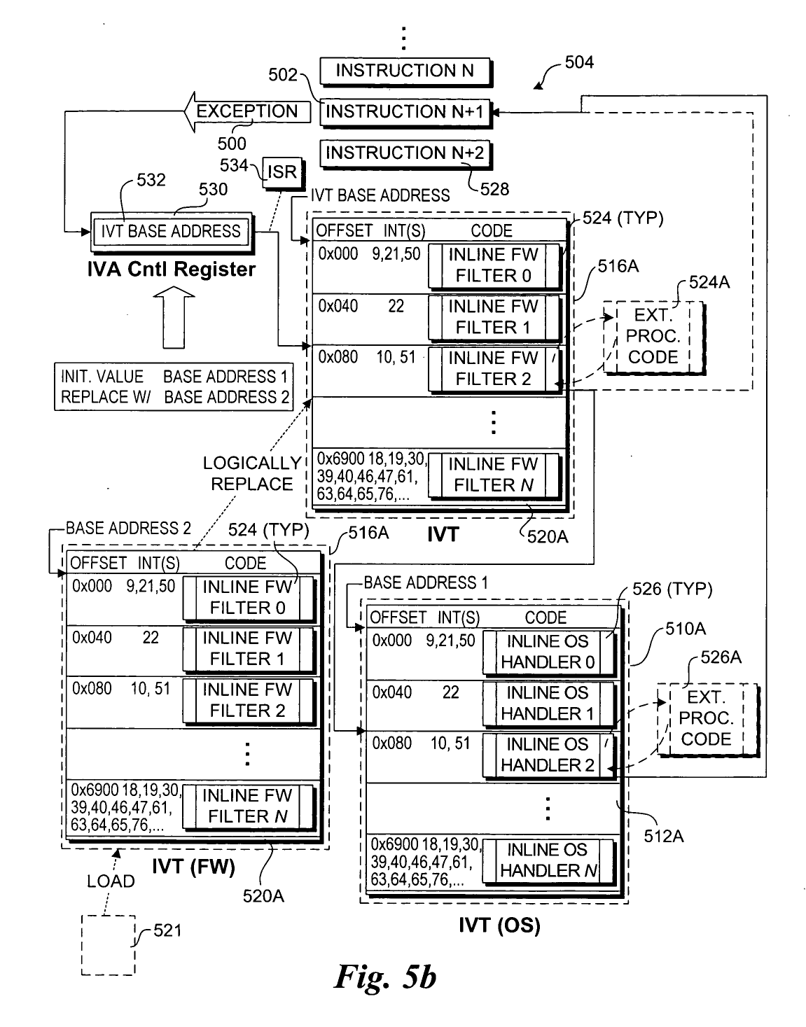

An exception handling process in accordance with an embodiment in which exception-handling code may be stored for inline execution is shown in FIG. 5. The process is similar in many respects to that discussed above with reference to FIG. 1. However, in this embodiment, an interrupt vector 508 vectors the instruction pointer to the entry point of an inline exception handler located in a memory space 510.

Under conventional practices, the inline exception handler would comprise an inline operating system exception handler 526 stored in an OS exception handler table 512. The OS exception handler table 512 originally occupies memory address space 510, but is relocated (physically or logically) to a memory address space 516 prior to OS runtime. In turn, a set of inline firmware exception filter/handlers 524 logically contained in a firmware exception inline filter table 520 is loaded into memory address space 510 after the OS exception handler table 512 is relocated.

The embodiment of FIG. 5 performs interrupt/exception handling in the following manner. The process is initiated in response to the detection of an exception 500 resulting from execution of an instruction 502 in an instruction stream 504. An appropriate exception vector 508 corresponding to the exception 500 (depicted as “VECTOR 2”) is determined by the processor, and the instruction pointer is vectored to a corresponding address in memory address space 510 that coincides with an entry point of an inline firmware filter/exception handler 524 that is coded to handle exceptions mapped to the VECTOR 2 exception vector 508. Once entered, the inline firmware filter/exception handler 524 performs its exception filter and/or handler tasks in a manner similar to firmware filter/exception handler 124 discussed above.

In some embodiments, the space allocated for all classes or certain classes of exception handlers is pre-determined based on an offset scheme, as illustrated by an address block 522. If the size of the inline firmware filter/exception handler 524 is larger than the address space allocated to its corresponding vector (e.g., address block 522), it will be necessary to locate at least a portion of the handler code at a memory address space that is external from memory address space 510. The “extra code” may comprise a portion of the filter/exception handling code, or may comprise an entire filter/exception handing procedure, as depicted by external procedure code 524A. In cases in which the entire filter/exception handling procedure is stored external from memory address space 510, the instruction at the entry point of address block 522 will comprise a pointer (i.e., vector) to the entry point of procedure code 524A in a manner analogous to the exception filter and handler pointers in FIGS. 1, 1a, and 1b.

In the case of firmware filter-only operations, after the code for the firmware-based filter exception handler has been executed, the instruction pointer is re-vectored to the entry point of the operating system exception handler 526 that would normally handle the exception under conventional practices. This coincides with the start of an address block 522A. This OS exception handler is analogous to OS exception handler 126 discussed above. As with firmware-based filter/exception handlers, a portion of all of the OS exception handler code may reside outside of address space 516, as depicted by external procedure code 526A.

After completion of the filter/exception handler(s), execution is returned to the instruction stream 504 in a manner similar to that discussed above with reference to the embodiment of FIG. 1. As before, depending on the type of exception, the instruction pointer may point to the instruction that initially caused the exception (e.g., for faults), the following instruction (e.g., for traps), or to some other instruction in the case of an abort exception. Also as before, in some embodiments a firmware inline filter/exception handler may perform all exception-handling operations, obfuscating the need for any of the exception handling to be performed by a corresponding operating system exception handler.

Details of embodiments that implement the technique of FIG. 5 for an Intel® IA-64 processor architecture (e.g., an Itanium® processor) are shown in FIGS. 5a and 5b. Many of the operations and logic of FIGS. 5a and 5b are analogous to operations and logic contained in FIGS. 1a and 1b, respectively. However, under the embodiments of FIGS. 5a and 5b, inline firmware filter/exception handlers 524 and OS exception handlers 526 are directly used without requiring a re-vectoring via corresponding pointers.

The IA-64 architecture supports two categories of interruptions: interruption vector address (IVA)-based interruptions and processor abstraction layer (PAL)-based interruptions. In accordance with conventional practices, IVA-based interruptions are handled by the operation system, while PAL-based interruptions are handled by the system firmware. For purposes of the embodiments herein, only IVA-based interruptions are considered.

Under the IA-64 architecture, an IVA control register 530 is used to specify a base address 532 of the processor's interruption vector table (IVT). The size of the IVT is 32 kilobytes (KB). The first 20 vectors in the IVT are designed to provide code space by allocating 64 bundles per vector (16 bytes per bundle) for performance-critical interruption handlers. The second 48 vectors provide 16 16-byte bundles per vector. Several vectors have more than one interruption associated with them. Information provided in an Interrupt Status Register (ISR) 534 (interruption control register CR-17) is used to identify the appropriate interruption.

In accordance with the embodiment of FIG. 5a, an operating system IVT 512A is loaded into a 32 KB memory address space 510 having a base address 1, and the IVT base address 532 is set to the base address 1 by the operating system in the conventional manner. Subsequently, the OS IVT 512A is relocated to a 32 KB memory address space 516 having a base address 2. The original content of memory address space 510 is then replaced with inline firmware exception filters/handlers 524, which are located at appropriate offsets from base address 1. This forms an IVT 520A. The inline firmware exception filters/handlers may be loaded as a contiguous set of components, or as individual components that are stored in a non-contiguous manner. The firmware components are loaded from a firmware store 521, which may comprise a local storage device, such as a flash device or disk drive, a remote storage resource that is accessed via a network, or a combination of storage devices.

Under the embodiment of FIG. 5b, which is roughly analogous to the embodiment of FIG. 1b, neither the operating system exception handlers or firmware exception filters/handlers are moved once they are loaded into memory. The process begins with an OS IVT 512A being loaded into a memory address space 510A having a base address 1. The IVT base address 532 in IVA control register 530 is then set to base address 1 by the operating system. In the meanwhile, a firmware-based IDT 520A is loaded from firmware storage 521 into a memory address space 516A. The may occur before or after the OS IVT 512A has been loaded into memory address space 510A. Subsequent to the operating system setting the IVT base address 532 to base address 1, the IVT base address 532 in IVA control register 530 is changed to base address 2, thus now pointing to the firmware-based IVT 520A rather than the OS IVT 512A. This has the effect of logically replacing the OS IVT 512 with the firmware-based IVT 520A.

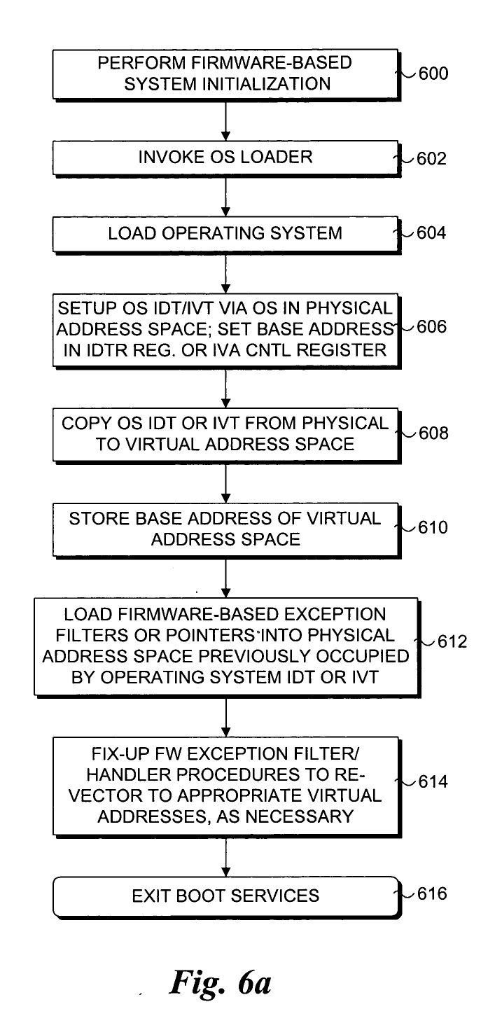

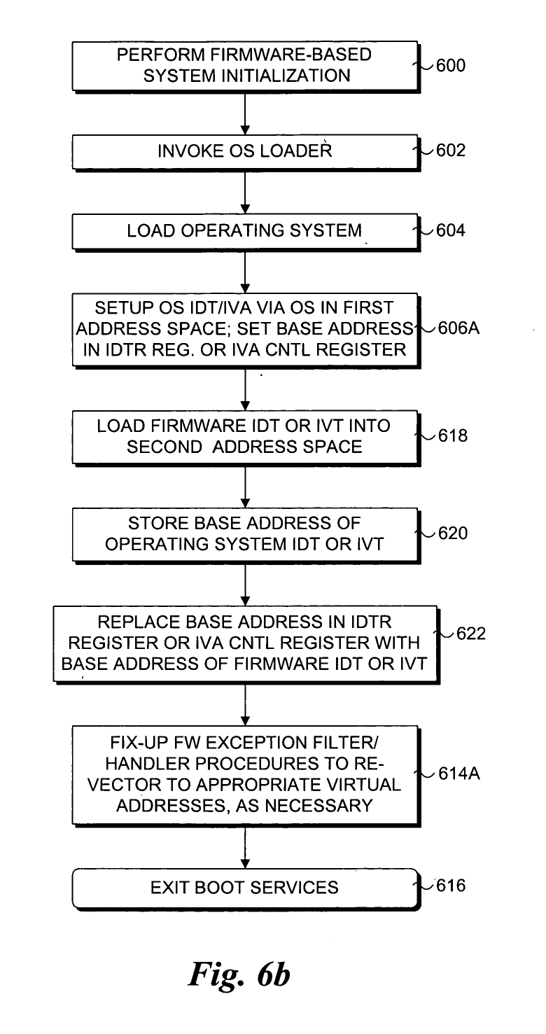

An embodiment of a flowchart showing operations that may be performed to set up the embodiments of FIGS. 1a and 5a is shown in FIG. 6a. The set-up process begins in a block 600, wherein firmware-based system initialization operations are performed. For example, the processor and memory are initialized, the power-on self-test (POST) is performed, and firmware interfaces are set up. In general, the operations of block 600 prepare the system for loading an operating system.

In one embodiment, the firmware is configured in accordance with an extensible firmware framework known as the Extensible Firmware Interface (EFI) framework (specifications and examples of which may be found at http:H/developer.intel.com/technology/efi). EFI is a public industry specification that describes an abstract programmatic interface between platform firmware and shrink-wrap operation systems or other custom application environments. The EFI framework include provisions for extending BIOS functionality beyond that provided by the BIOS code stored in a plafform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

After the firmware-based initialization operations are completed, an operating system loader is invoked in a block 602 to begin loading the operation system, which is continued in a block 604. During this process, the operating system IDT or IVA (as applicable) is set up via the operating system in a physical address space (i.e., a portion of system memory). The base address for the IDTR register or IVA control register (as applicable) is set to point to the start of the physical address space. These operations are performed in a block 606.

In a block 608, the OS IDT or IVA is copied from the physical address space to a virtual address space (i.e., from a first memory address space to a second memory address space). The base address of the virtual address space is then stored in a block 610. This base address should be stored in a manner that enables the base address to be retrieved by the system firmware. In one embodiment, this base address is stored in an EFI system table.

Firmware-based exception filters/handlers or pointers to the same are loaded into the physical address space previously occupied by the OS IDT or IVT in a block 612. Any necessary fix-ups to the firmware exception filters/handlers to re-vector the instruction pointer to appropriate virtual address at which a corresponding OS pointer or exception handler is located are performed in a block 614. For example, at the completion of a given firmware exception filter/handler, the instruction pointer needs to be re-vectored to an OS exception handler pointer (for IA-32) or an OS exception handler (for IA-64). In one embodiment, this fix-up includes rewriting the jump-to address in the last statement of each firmware exception filter/handler. An appropriate address may be determined by retrieving the base address of the virtual address space and adding an applicable offset at which the corresponding OS pointer or handler will reside. In one embodiment, the offsets are hard-coded and added to a base address variable that references a value stored at a pre-determined location that coincides with the location of the base address of the virtual address space previously stored in block 610. In one embodiment, this pre-determined location is determined by referencing an EFI system table variable.

The set-up process is completed by exiting the firmware boot services in a block 616. At this point, the operating system is ready to perform runtime operations, and the system is set-up to perform firmware-based runtime exception filtering and/or handling.

An embodiment of a flowchart showing operations that may be performed to set up the embodiments of FIGS. 1b and 5b is shown in FIG. 6b. Many of the operations are analogous to those shown in FIG. 6a; these analogous operations share the same reference numbers in both FIGS. 6a and 6b. Accordingly, only the differences between the two set-up processes will be further discussed.

After the operations of blocks 600, 602, and 604, the operating system IDT or IVA is set up via the operating system in a first memory address space. The base address of this first address space is then set in the IDTR register or the IVA control register, as applicable. These operations are depicted in a block 606A.

In a block 618, the firmware-based IDT (pointers) or IVT (procedures) components are loaded into a second memory address space. The base address of the first address space at which the OS IDT or IVT is located is stored in a block 620. The base address in the IDTR register or IVA control register is then replaced with the base address of the firmware IDT or IVT (i.e., the base address of the second address space) in a block 622. Any necessary fix-up operations are performed in a block 614 in a manner analogous to similar operations performed in block 614 of FIG. 6a. In particular, the referenced base address is now the base address of the OS IDT or IVT stored in block 620.

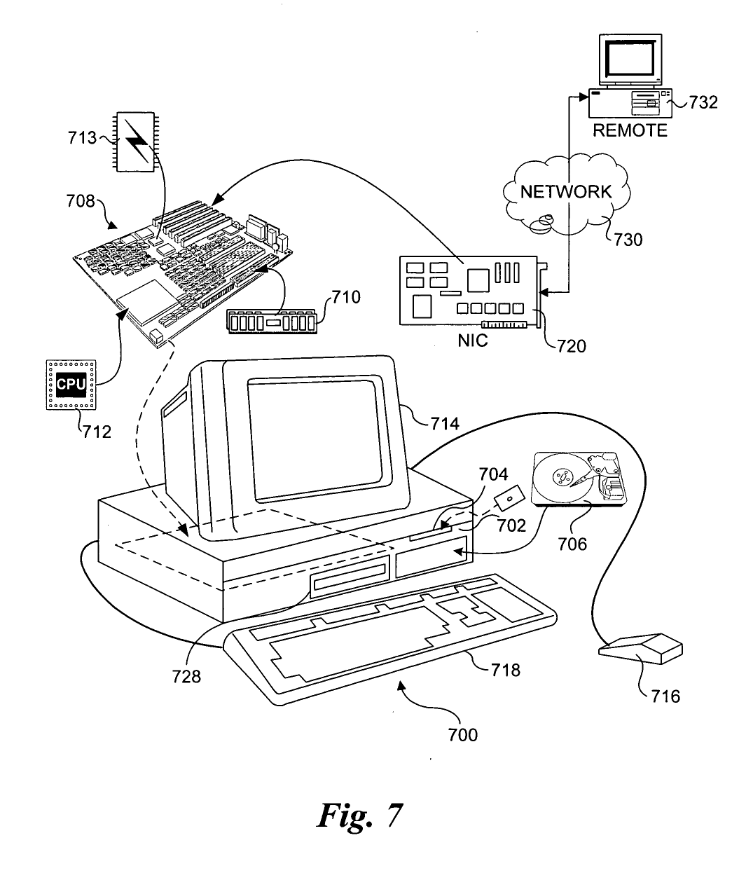

FIG. 7 illustrates an embodiment of an exemplary computer system 700 to practice embodiments of the invention described above. Computer system 700 is generally illustrative of various types of computer devices, including personal computers, laptop computers, workstations, servers, etc. For simplicity, only the basic components of the computer system are discussed herein. Computer system 700 includes a chassis 702 in which various components are housed, including a floppy disk drive 704, a hard disk 706, a power supply (not shown), and a motherboard 708. Hard disk 706 may comprise a single unit, or multiple units, and may optionally reside outside of computer system 700. The motherboard 708 includes memory 710 coupled in communication with one or more processors 712 via appropriate busses and/or chipset components. Memory 710 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 712 may be a conventional microprocessor including, but not limited to, a CISC (complex instruction set computer) processor, such as an Intel Corporation x86, Pentium®, or Itanium® family microprocessor, a Motorola family microprocessor, or a RISC (reduced instruction set computer) processor, such as a SUN SPARC processor or the like.

The computer system 700 also includes one or more non-volatile memory devices on which firmware for effectuating all or a portion of the firmware-based services described herein is stored. Such non-volatile memory devices include a flash device 713. Other non-volatile memory devices include, but are not limited to, an Erasable Programmable Read Only Memory (EPROM), an Electronically Erasable Programmable Read Only Memory (EEPROM), or the like. The computer system 700 may include other firmware devices as well (not shown). Firmware may optionally be stored on hard disk 706 (e.g., in an EFI partition).

A monitor 714 is included for displaying graphics and text generated by firmware, software programs and program modules that are run by computer system 700. A mouse 716 (or other pointing device) may be connected to a serial port, USB (Universal Serial Bus) port, or other like bus port communicatively coupled to processor 712. A keyboard 718 is communicatively coupled to motherboard 708 in a similar manner as mouse 716 for user entry of text and commands. In one embodiment, computer system 700 also includes a network interface card (NIC) 720 or built-in NIC interface (not shown) for connecting computer system 700 to a computer network 730, such as a local area network (LAN), wide area network (WAN), or the Internet. In one embodiment, network 730 is further coupled to a remote computer 732, such that computer system 700 and remote computer 732 can communicate. In one embodiment, a portion of the computer system's firmware and/or pre-boot environment data is loaded during the firmware system initialization from remote computer 732. For example, data corresponding to firmware exception filters/handlers may be stored on remote computer 732 and loaded into memory 710 during this system initialization phase.

Computer system 700 may also optionally include a compact disk-read only memory (“CD-ROM”) drive 728 into which a CD-ROM disk may be inserted so that executable files, such as an operating system, and data on the disk can be read or transferred into memory 710 and/or hard disk 706. Other mass memory storage devices may be included in computer system 700.

In another embodiment, computer system 700 is a handheld or palmtop computer, which are sometimes referred to as Personal Digital Assistants (PDAs). Handheld computers may not include a hard disk or other mass storage, and the executable programs are loaded from a corded or wireless network connection into memory 710 for execution by processor 712. A typical computer system 700 will usually include at least a processor 712, memory 710, and a bus (not shown) coupling the memory 710 to the processor 712.

It will be appreciated that in one embodiment, computer system 700 is controlled by operating system software that includes a file management system, such as a disk operating system, which is part of the operating system software. For example, one embodiment of the present invention utilizes a Microsoft Windows® operating system for computer system 700. In another embodiment, other operating systems such as, but not limited to, an Apple Macintosh® operating system, a Linux-based operating system, the Microsoft Windows CE® operating system, a Unix-based operating system, the 3Com Palm® operating system, or the like may also be use in accordance with the teachings of the present invention.

Thus, embodiments of this invention may be used as or to support a firmware and software code executed upon some form of processing core (such as processor 712) or otherwise implemented or realized upon or within a machine-readable medium. A machine-readable medium includes any mechanism that provides (i.e., stores and/or transmits) information in a form readable by a machine (e.g., a computer, network device, personal digital assistant, manufacturing tool, any device with a set of one or more processors, etc.). In addition to recordable media, such as disk-based media, a machine-readable medium may include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
vectoring an instruction pointer to a firmware-based exception filter in response to an exception;
executing the firmware-based exception filter; and
re-vectoring the instruction pointer to an operating system (OS) exception handler configured to handle the exception.

2. The method of claim 1, wherein execution of the firmware-based exception filter performs operations including saving at least one processor register value to a storage device.

3. The method of claim 1, wherein execution of the firmware-based exception filter performs operations including saving at least a portion of system memory to a storage device.

4. The method of claim 1, further comprising:
loading a set of OS exception handler pointers into a first memory address space;
relocating the set of OS exception handler pointers to a second memory address space; and
loading a set of firmware-based exception filter pointers into the first address space.

5. The method of claim 4, further comprising:
storing a base address of the second memory address space; and
employing the base address of the second memory address space to re-vector the instruction pointer to an OS exception handler pointer to the OS exception handler configured to handle the exception.

6. The method of claim 1, further comprising:
loading a set of OS exception handlers into a first memory address space;
relocating the set of OS exception handlers to a second memory address space; and
loading a set of firmware-based exception filters into the first address space.

7. The method of claim 6, further comprising:
storing a base address of the second memory address space; and
employing the base address of the second memory address space to re-vector the instruction pointer to the OS exception handler configured to handle the exception.

8. The method of claim 1, further comprising:
loading a set of OS exception handler pointers into a first memory address space;
setting a processor exception vector register to include a base address of the first memory address space;
loading a set of firmware-based exception filter pointers into a second address space; and
replacing the base address of the first memory address space with the base address of the second memory address space in the processor exception vector register.

9. The method of claim 8, further comprising:
storing a base address of the first memory address space; and
employing the base address of the first memory address space to re-vector the instruction pointer to an OS exception handler pointer to the OS exception handler configured to handle the exception.

10. The method of claim 1, further comprising:
loading a set of OS exception handlers into a first memory address space;
setting a processor exception vector register to include a base address of the first memory address space;
loading a set of firmware-based exception filters into a second address space; and
resetting the processor exception vector register to include a base address of the second memory address space;

11. The method of claim 10, further comprising:
storing a base address of the first memory address space; and
employing the base address of the first memory address space to re-vector the instruction pointer to the OS exception handler configured to handle the exception.

12. The method of claim 1, further comprising:
loading the firmware-based exception filter into system memory; and
fixing up code in the firmware-based exception filter to re-vector the instruction pointer to one of the OS exception handler configured to handle the exception or a pointer to the OS exception handler configured to handler the exception.

13. A method, comprising:
loading a set of operating system (OS)-based exception handler components into system memory;
physically or logically replacing the set of OS-based exception handler components with a corresponding set of firmware-based exception filter and/or handler components;
vectoring an instruction pointer to a firmware-based exception filter and/or handler in response to an OS runtime exception; and
executing the firmware-based exception filter and/or handler.

14. The method of claim 13, further comprising re-vectoring the instruction pointer to an operating system (OS) exception handler configured to handle the OS run-time exception after the firmware-based exception filter and/or handler has been executed.

15. The method of claim 14, further comprising fixing up code in the firmware-based exception filter and/or handler to re-vector the instruction pointer to one of the OS exception handler configured to handle the OS runtime exception or a pointer to the OS exception handler configured to handle the OS runtime exception.

16. The method of claim 13, wherein the set of OS-based exception handlers are physically replaced by:
copying the set of OS-based exception handlers from a physical address space to a virtual address space; and
overwriting the physical address space with the set of firmware-based exception filter and/or handler components.

17. The method of claim 13, wherein the set of OS-based exception handlers are logically replaced by:
loading the set of OS-based exception handlers into a first memory address space having a first base address; and
loading the set of firmware-based exception filter and/or handler components into a second address space having a second base address; and
replacing the first base address with the second base address in a register that is used to locate the base address of a table containing one of a set of exception handler procedures or pointers to a set of exception handler procedures.

18. A machine-readable medium to provide instructions, which when executed perform operations including:
determining a first base address of a set of operating system (OS)-based exception handler components that have been loaded into a first memory address space;
storing the first base address;
loading a set of firmware-based exception filter and/or handler components into a second memory address space having a second base address; and
setting an exception vector register to have a base address corresponding to the second base address.

19. The machine-readable medium of claim 18, further to provide the set of firmware-based exception filter and/or handler components.

20. The machine-readable medium of claim 18, wherein the medium comprises a firmware storage device.

21. The machine-readable medium of claim 18, to provide further instructions to perform operations including:
filtering a runtime exception using a firmware-based exception filter; and
re-vectoring an instruction pointer to an operating system (OS) exception handler configured to handle the runtime exception.

22. A machine-readable medium to provide instructions, which when executed perform operations including:
moving a set of operating system (OS)-based exception handler components from a first memory address space having a first base address to a second memory address space having a second base address;
storing the second base address; and
loading a set of firmware-based exception filter and/or handler components into the first memory address space.

23. The machine-readable medium of claim 22, further to provide the set of firmware-based exception filter and/or handler components.

24. The machine-readable medium of claim 22, wherein the medium comprises a firmware storage device.

25. The machine-readable medium of claim 22, to provide further instructions to perform operations including:
filtering a runtime exception using a firmware-based exception filter; and
re-vectoring an instruction pointer to an operating system exception handler configured to handle the runtime exception.

26. A system, comprising:
a processor;
memory, coupled to the processor;
a flash device, having firmware instructions stored thereon to perform operations in combination with logic programmed into the processor, the operations including:
loading a firmware-based exception filter into memory;
detecting a runtime exception;
vectoring an instruction pointer to the firmware-based exception filter in response to the runtime exception;
executing the firmware-based exception filter; and
re-vectoring the instruction pointer to an operating system (OS) exception handler configured to handle the runtime exception.

27. The system of claim 26, further comprising a network interface coupled to the processor, wherein execution of firmware instructions loads a firmware-based exception filter from a network storage device via the network interface into the memory.

28. The system of claim 26, wherein execution of the firmware instructions performs further operations including:
determining a first base address of a set of OS-based exception handler components that have been loaded into a first address space of the memory;
storing the first base address;
loading a set of firmware-based exception filter and/or handler components into a second address space of the memory having a second base address; and
setting an exception vector register in the processor to have a base address corresponding to the second base address.

29. The system of claim 26, wherein execution of the firmware instructions perform the further operation of fixing up code in the firmware-based exception filter to re-vector the instruction pointer to one of the OS exception handler configured to handle the runtime exception or a pointer to the OS exception handler configured to handler the runtime exception.

30. The system of claim 26, wherein execution of the firmware instructions performs further operations including:
moving a set of OS-based exception handler components from a first address space in the memory having a first base address to a second address space in the memory having a second base address;
storing the second base address; and
loading a set of firmware-based exception filter and/or handler components into the first memory address space.
